(19) United States
(12) Patent Application Publication
(10) Pub. No.: US 2023/0050553 A1
(43) Pub. Date: Feb. 16, 2023

(54) REAL-TIME GAIN CALIBRATION OF A SENSOR

(71) Applicant: TEKNOLOGIAN TUTKIMUSKESKUS VTT OY, Espoo (FI)

(72) Inventors: Tapio PERNU, Espoo (FI); Panu HELISTÖ, Espoo (FI)

(21) Appl. No.: 17/796,632

(22) PCT Filed: Jan. 29, 2021
(86) PCT No.: PCT/FI2021/050061

§ 371 Date: Jul. 29, 2022

(30) Foreign Application Priority Data
Jan. 31, 2020 (FI) 20205103

(51) Int. Cl. G01L 13/02; G01L 9/00; G01L 27/00

(52) U.S. Cl. CPC G01L 13/025; G01L 9/0052; G01L 9/0072; G01L 27/005

(57) ABSTRACT

According to an aspect there is provided an apparatus comprising at least one electrode and a movable sensor membrane, wherein the apparatus comprises means for: measuring a voltage or a current; determining an amount of external pressure based on the measured voltage or current; based on the determined amount of external pressure, providing electrostatic feedback force such that the movable sensor membrane is undeflected; and determining a correlation between the electrostatic force feedback and the external pressure.

### FIELD

Examples described herein relate to sensors and their calibration.

### BACKGROUND

Sensors are increasingly found in all types of devices. Starting from small scale consumer applications to industrial sites, sensors provide data that can be used to monitor the surrounding environment and/or the functioning of a device itself. Therefore, it is desirable to verify that the data provided by one or more sensors is reliable or can be interpreted in a reliable manner.

### BRIEF DESCRIPTION

According to an aspect, there is provided a computer-implemented method comprising: measuring a voltage or a current, determining an amount of external pressure based on the measured voltage or current, based on the determined amount of external pressure, providing electrostatic feedback force such that the movable sensor membrane is undeflected, and determining a correlation between the electrostatic force feedback and the external pressure.

According to another aspect, there is provided a computer-implemented method comprising: measuring a voltage or a current, determining an amount of membrane deflection based on the measured voltage or current, based on the determined amount of membrane deflection, providing electrostatic feedback force such that the movable sensor membrane is undeflected, and determining an external pressure based on the electrostatic force feedback.

According to another aspect there is provided an apparatus comprising at least one electrode and a movable sensor membrane, wherein the apparatus comprises means for: measuring a voltage or a current; determining an amount of external pressure based on the measured voltage or current; based on the determined amount of external pressure, providing electrostatic feedback force such that the movable sensor membrane is undeflected; and determining a correlation between the electrostatic force feedback and the external pressure.

According to another aspect there is provided an apparatus comprising at least one electrode and a movable sensor membrane, wherein the apparatus comprises means for: measuring a voltage or a current, determining an amount of membrane deflection based on the measured voltage or current, based on the determined amount of membrane deflection, providing electrostatic feedback force such that the movable sensor membrane is undeflected, and determining an external pressure based on the electrostatic force feedback.

According to another aspect, there is provided a computer program product readable by a computer and, when executed by the computer, configured to cause the computer to execute a computer process comprising: measuring a voltage or a current, determining an amount of external pressure based on the measured voltage or current, based on the determined amount of external pressure, providing electrostatic feedback force such that the movable sensor membrane is undeflected, and determining a correlation between the electrostatic force feedback and the external pressure.

According to another aspect, there is provided a computer program product readable by a computer and, when executed by the computer, configured to cause the computer to execute a computer process comprising: measuring a voltage or a current, determining an amount of membrane deflection based on the measured voltage or current, based on the determined amount of membrane deflection, providing electrostatic feedback force such that the movable sensor membrane is undeflected, and determining an external pressure based on the electrostatic force feedback.

According to another aspect, there is provided an apparatus comprising means for measuring a voltage or a current, determining an amount of external pressure based on the measured voltage or current, based on the determined amount of external pressure, providing electrostatic feedback force such that the movable sensor membrane is undeflected, and determining a correlation between the electrostatic force feedback and the external pressure.

According to another aspect, there is provided an apparatus comprising means for measuring a voltage or a current, determining an amount of membrane deflection based on the measured voltage or current, based on the determined amount of membrane deflection, providing electrostatic feedback force such that the movable sensor membrane is undeflected, and determining an external pressure based on the electrostatic force feedback.

According to another aspect, there is provided an apparatus comprising at least one electrode and a movable sensor membrane, wherein the apparatus further comprises: at least one processor, and at least one memory including a computer program code, wherein the at least one memory and the computer program code are configured, with the at least one processor, to cause the apparatus to: measure a voltage or a current, determine an amount of external pressure based on the measured voltage or current, based on the determined amount of external pressure, provide electrostatic feedback force such that the movable sensor membrane is undeflected, and determine a correlation between the electrostatic force feedback and the external pressure.

According to another aspect, there is provided an apparatus comprising at least one electrode and a movable sensor membrane, wherein the apparatus further comprises: at least one processor, and at least one memory including a computer program code, wherein the at least one memory and the computer program code are configured, with the at least one processor, to cause the apparatus to: measuring a voltage or a current, determining an amount of membrane deflection based on the measured voltage or current, based on the determined amount of membrane deflection, providing electrostatic feedback force such that the movable sensor membrane is undeflected, and determining an external pressure based on the electrostatic force feedback.

### LIST OF DRAWINGS

In the following, the invention will be described in greater detail with reference to the embodiments and the accompanying drawings, in which

FIG. 1 illustrates examples of source of errors.

FIG. 2 illustrates an exemplary embodiment of a pressure sensor.

FIG. 3 illustrates an exemplary embodiment of a circuitry.

FIG. 4 illustrates an exemplary embodiment of an apparatus comprising a pressure sensor.

### DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

A sensor may be understood as an apparatus that may be an independent apparatus or it may be comprised in another apparatus. The sensor may be connected to another apparatus that comprises at least one processor, at least one memory and computer program code that are configured to cause processing of data received from the sensor. The sensor may therefore have an output connection that enables the sensor to provide data as output. The data may be for example measurement data regarding the environment surrounding the sensor. In some exemplary embodiments the sensor may be configured to process the measurement data before providing it using one or more outputs while in some other exemplary embodiments the measurement data may be provided by the sensors using the one or more outputs without the sensor processing the data first.

In some exemplary embodiments the sensor may comprise one or more inputs that are configured to receive instructions regarding the functioning of the sensor for example. Yet, in some other exemplary embodiments, the sensor may not be configured to receive any inputs but merely provide data. It is envisaged that 5G will enable utilization of vast amounts of sensors that provide data but do not necessarily receive inputs. This may be beneficial for example if buildings or bridges are to be remotely monitored.

The sensor may provide data using a wired or wireless connection. For example, if the sensor is comprised in another apparatus, the sensor may provide the data using a wired connection. If the sensor is, however, to monitor a structure such as a structure of a bridge for example, the sensor may periodically provide data using wireless connection such as 5G.

Apparatuses, like mobile devices such as mobile phones, tablet computers and/or smart watches benefit from sensors. Yet, to keep the size of the apparatus small, the footprint of the sensors are also to be small. A category of sensors that may be used in such apparatuses is micro electro-mechanical system, MEMS, sensors, that sense physical signals such as acceleration force, pressure or radiation, and convert those into electrical signals that may be processed by one or more processors. MEMS sensors are beneficial in areas where real time data is relied upon as input to determine an appropriate output. MEMS sensors may be used for example in pressure/temperature sensors, accelerometers, and gyroscopes found in appliances, automobiles, aviation and so on.

Some MEMS sensors are configured to sense changes in pressure. This may be achieved by a sensing the amount a sensor membrane deforms due to the pressure that is to be measured. In some exemplary embodiments, the deformation may be sensed using a strain sensor. These sensors may utilize piezo-resistive measurement techniques that may have benefits such as simple design structure, simple fabrication process and/or simple structure to receive the output from the sensor. Yet, piezo-resistive techniques are typically susceptible to variation in temperature and do not respond linearly to temperature changes. This may introduce the need to calibrate the sensors frequently.

In some other exemplary embodiments, a sensor may comprise a differential capacitive structure and the sensor may be for example a capacitive sensor or a differential pressure sensor such as a MEMS pressure sensor that utilizes capacitive technology for sensing a change in the pressure. An example of such a sensor is a capacitive accelerometer in which a proof mass due to acceleration is converted to a proportional capacitance change. The capacitance change is then subsequently converted and amplified into a voltage signal. A capacitive accelerometer may be designed for example such that it has a simultaneous capacitance increase and decrease with the same acceleration with differential sensing.

In some exemplary embodiments the sensor may be a differential pressure sensor, the sensing may be implemented using two metal plates. The capacitance between the two metal plates changes if the distance between these two plates changes. A variable capacitance pressure transducer then measures the change in capacitance between sensor membrane, that may be metal, and a fixed metal plate. For example, the sensor membrane may be flexible and configured to react to a change in pressure thereby providing air pressure measurement. Along with the flexible sensor membrane there may be a stiff metal membrane that does not react to the change in the air pressure thereby providing a stable reference for a measurement. This type of a structure enables differential pressure measurement while both sensor membranes, flexible and stiff are exposed to the same temperature changes which enables negating temperature drift effects.

In general, capacitive sensors may be able to operate over a wide temperature range and are tolerant of overpressure conditions that last for a short time period. Capacitive sensors may be used to measure a wide range of pressure from vacuum, such as 2.5 mbar or 250 Pa, to high pressures such as up to around 10,000 psi (70 MPa). As no DC current flows through the capacitor, capacitive sensors may, in some examples, be considered as inherently low power. Yet, in some other examples, producing an excitation signal, such as an AC signal, for reading the capacitance of the sensor may require a greater current than a DC signal that is needed for determining the output of a piezoresistive sensor.

In some exemplary embodiments, an apparatus comprising a capacitive sensor may be passive and therefore may not require a power source. In such an exemplary embodiment, an excitation signal may be provided by an external reader, which makes capacitive sensors suitable for wearable or implanted medical devices for example.

Capacitive sensors may exhibit low hysteresis and good repeatability of measurements. Capacitive sensor may also have low temperature sensitivity and their response time may be in the order of milliseconds. For some MEMS capacitive sensors, the response time may be even faster.

In some exemplary embodiments, a capacitive sensor may exhibit non-linearity as the output is inversely proportional to the gap between the parallel electrodes. This may be addressed by using the sensor such that, the sensor membrane is in contact with an insulating layer on the lower electrode. It is also to be noted that stray capacitance may be minimised by having electronics as close as possible to the sensor as is the case with MEMS technology.

Although capacitive MEMS accelerometers are typically utilized such that an interface circuit for the MEMS accelerometer uses a charge-based approach, in some exemplary embodiments other approaches may also be utilized. For example, frequency-based approaches may be utilized in some exemplary embodiments.

In some exemplary embodiments, a differential capacitive MEMS pressure sensor may have an integrated MEMS valve. The integrated MEMS valve may enable zero offset calibration. Offset may be understood as the output of the pressure sensor to be higher or lower than an ideal output. Zero offset calibration on the other hand may be understood as a process in which a zero offset value is updated for the pressure sensor.

A microvalve may be an active or a passive microvalve. An active microvalve may comprise a mechanically movable membrane that may be coupled to an actuator that is configured to close an orifice to block a flow path between inlet and outlet ports. The actuator may be for example an integrated magnetic, electrostatic, piezoelectric or thermal micro-actuator. For passive microvalves an operational state may be determined by a fluid which the passive microvalve controls.

To control a flow of gas, such as air, a MEMS microvalve may be used. This may be beneficial as integration of the actuation mechanism of the MEMS microvalve with the other MEMS microvalve components allows component miniaturization. Due to the achieved small scale of the component, a rapid response time and a low-power consumption may be achieved. Yet, it is to be noted that in some exemplary embodiments, other types of valves, such as three-way valves, may be used as well.

In some exemplary embodiments, the sensor may be a barometric sensor. In such an exemplary embodiment, the sensor comprises an electrode and a movable sensor membrane. The sensor membrane may be located opposite to the electrode. Further, the other side of the sensor membrane may be opposite to a vacuum. This type of structure, a barometric structure, may be used as an alternative to the above-described differential structure of a sensor.

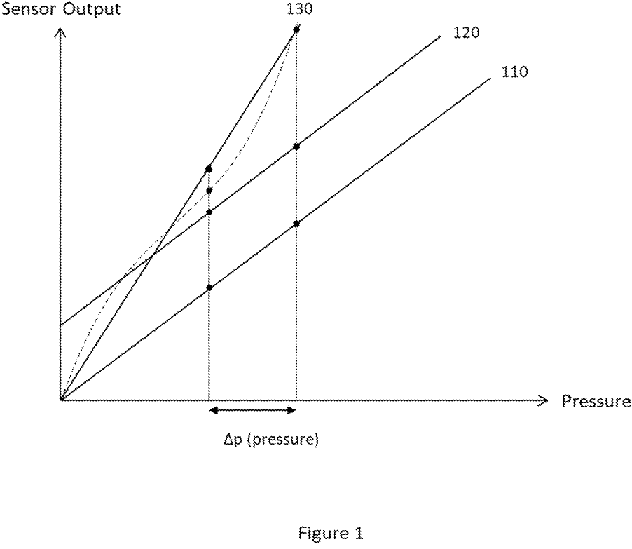

Data produced by a sensor may be susceptible to errors. This may be due to various reasons. FIG. 1 illustrates errors that may distort data output by a differential capacitive MEMS pressure sensor. The x-axis in FIG. 1 illustrates the amount of pressure applied to a sensor membrane of the differential capacitive MEMS pressure sensor that is the apparatus in this exemplary embodiment. The y-axis in FIG. 1 illustrates the output from the apparatus. Graph 110 in this exemplary embodiment illustrates the ideal output from the apparatus. Graph 120 on the other hand illustrates on offset error. In some exemplary embodiments, the offset error illustrated by 120 may be eliminated by using for example a 3-way valve that allows closing pressure gates for the duration of resetting the offset to zero.

Graph 130 in FIG. 1 illustrates error introduced by gain and non-linearity. Gain error may be understood as the deviation from ideal output. The error deviates from the graph 110 illustrating the ideal output unlike offset, which produces the error already at zero pressure. Gain error may be compensated by utilizing calibration. Calibration may be done using software or hardware.

In some exemplary embodiments, calibration may be done using a system that is coupled to the differential capacitive pressure sensor, which may be a MEMS pressure sensor. In such exemplary embodiments, the differential capacitive pressure sensor may be stimulated by an electrostatic force to compensate a deformation of a flexible sensor membrane comprised in the differential capacitive pressure sensor thereby enabling an extraction of sensor parameters, which may then be modelled, stored and utilized for calibration and recalibration of the differential capacitive pressure sensor. Alternatively, or additionally, a comparison between measurements with respect to time across a time differential may be performed. This comparison may then be used to initially calibrate, adjust, and/or recalibrate the differential capacitive pressure sensor at a later time with various values relating to one or more parameters of the differential capacitive sensor, such as surface are of the sensor membrane, spring constants, dimensions, distance between electrodes, height from membrane to a cavity bottom, a permittivity constant, applied pressure and/or linearization polynomial coefficients.

Calibration and recalibration of the differential capacitive pressure sensor may comprise utilizing electrostatic forces generated by voltages applied to the plates of the differential capacitive pressure sensor and evaluating corresponding changes of the capacitance values thereby generating a model of the parameters. A calibration component may then be configured to calibrate the differential capacitive pressure sensor to a set of target values with a set of parameters derived from the measurements of the sets of capacitance values. This calibration however is not performed in real time.

In order to achieve a more stable and accurate sensor, that may comprise a differential capacitive structure or a barometric structure, it is beneficial if the calibration, such as gain calibration, may be performed in real-time. This would enable the calibration to be performed during normal operation of the sensor, which may be for example a differential capacitive pressure sensor such as a MEMS pressure sensor or an accelerometer.

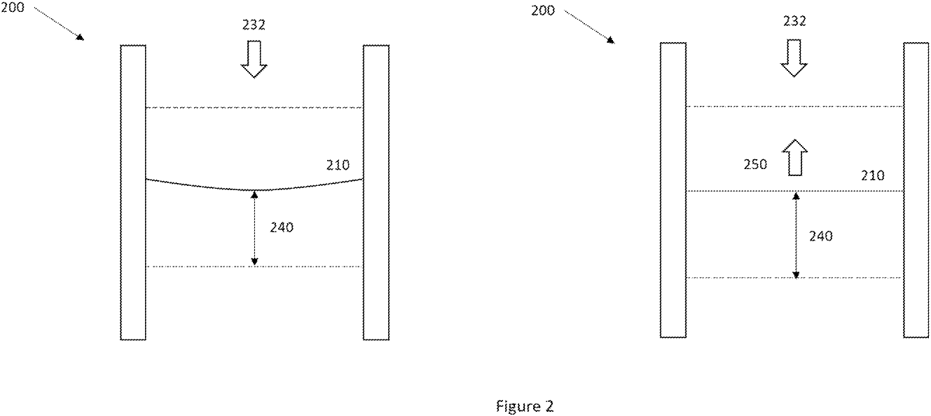

FIG. 2 illustrates an exemplary embodiment of an apparatus 200 that in this exemplary embodiment is a differential capacitive MEMS pressure sensor. It is to be noted that in some alternative exemplary embodiments the apparatus may be another type of sensor comprising a differential capacitive structure such as an accelerometer. In some other exemplary embodiments, the apparatus 200 may also comprise an integrated microvalve such as a MEMS microvalve. The MEMS microvalve may be a three-way valve. Alternatively, any other suitable type of a three-way valve may be used in exemplary embodiments that utilize a valve. In such exemplary embodiments, the valve may be used for calibrating offset. The apparatus 200 further comprises a sensor membrane 210 that is flexible and deforms as pressure 232 is applied onto it.

In order to determine the gain error, a force that in this exemplary embodiment is electrostatic force feedback 250 may be utilized. By applying electrostatic force feedback 250 such that its amount is comparable to air pressure, the sensor membrane 210 may be kept still and undeflected. If the sensor membrane 210 is kept undeflected and still, then the gap 240 remains constant and the surface area A of the sensor membrane 210 is known.

As the surface area of the sensor membrane 210 remains constant and that gap 240 is known, a correlation between the force 232 caused by external pressure and the electrostatic force feedback 250 may be determined. The force 232 caused by the external pressure may be determined as F = pA and thereby the pressure may be determined as p =

$$\frac{F}{A}$$

. On the other hand,

$$\text{F=kx+} ε \frac{A}{2 {d}^{2}} {V}^{2} .$$

In this equation, k represents a spring constant, x represents a displacement, A represents the area of the sensor membrane, V represents voltage, ε represents permittivity and d represents a nominal gap between an electrode plate and the sensor membrane. In the case x=0,

$$\text{p} = \frac{ε {V}^{2}}{2 {d}^{2}} .$$

If there is pressure applied to the sensor and that pressure is not compensated by a voltage, d becomes d+x or d-x in which x represents deviation caused by the deflection to the nominal d. When a voltage V is applied to drive the membrane to the nominal position with force feedback from the RF circuit used to read the capacitance output or by other means, the electrostatic force may be used to determine the differential pressure as the applied voltage V can be accurately measured, the surface area of the sensor membrane does not affect and the gap d, which is the nominal gap 240, is known and undeflected.

The voltage V may be an AC or DC. If AC is used, then the voltage may be understood as an RMS (root-mean-square) voltage. Also, the feedback voltage may now become a feedback current and the formula may be written as

$${\text{F}}_{\text{rms}} \text{=} \frac{{I}^{2} r m s}{2 ε A {ω}^{2}}$$

when the membrain is not deflected.

It is to be noted that in some alternative exemplary embodiments, the formulas used may differ from what is disclosed above. This may be due to for example elastic characteristics of the sensor membrane, attachment means used to attach the sensor membrane to the structure of the sensor and/or parasite capacitance and dynamic characteristics of the sensor. For example, if the sensor membrane is attached to the sensor such that its edges are rigid, the denominator may be determined to be 6 instead of 2 when the displacement is rather small. In such examples, x may be determined to be the maximum displacement of the sensor membrane instead of an average displacement. Yet, the principle of the phenomena remains the same in the examples mentioned.

It is also to be noted that the sensor may alternatively comprise a barometric structure. In such an exemplary embodiment, the electrostatic force feedback may still be applied such that the deflection of the sensor membrane is compensates and the sensor membrane is kept undeflected.

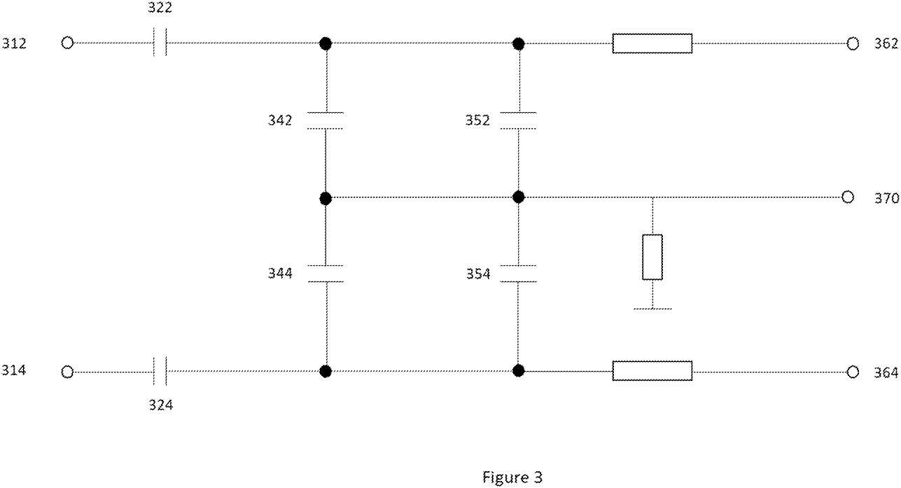

FIG. 3 illustrates an exemplary embodiment of a circuit that may be comprised in an apparatus such as the apparatus 200. The exemplary circuit in FIG. 3 is an equivalent circuit that may be used to obtain output from the apparatus 200. In this exemplary embodiment, capacitance measurement is used to determine mid-point of a sensor membrane such as sensor membrane 210. It is to be noted that in some alternative exemplary embodiments the mid-point may be determined using piezo-resistive measurement or optical measurement.

In this exemplary embodiment, there are two excitations, excitation 312 and 314, followed by capacitors 322 and 324 that are for DC isolation. Next in the circuit there are two MEMS capacitors 342 and 344. Due to the proximity of capacitors 342 and 344 to each other, parasitic capacitance, or stray capacitance, may occur as the electric field between them may cause electric charge to be stored on them. Therefore, there are stray capacitors 352 and 354 also comprised in the circuit of this exemplary embodiment. In the circuit of FIG. 3, there are also two DC Feedback voltages 362 and 364. The voltage to be fed back may in some exemplary embodiments be dependent on the deflection of the electronic membrane. To provide an output, the circuit further comprises a capacitance readout 370.

In the above described exemplary embodiments a mid-point of a sensor membrane of a differential capacitive pressure sensor may be defined with a nulling valve that may be a microvalve integrated to the differential capacitive pressure sensor as described above. Then during normal operation, the sensor membrane may be maintained at the mid-point with electrostatic force feedback, which may be caused by a DC compensation voltage or, in some alternative exemplary embodiments, by an AC compensation voltage. Based on the compensation voltage, a pressure may then be determined and thereby the gain error may be determined in real-time during operation of the differential capacitive pressure sensor, which may be a MEMS pressure sensor. Determining may be achieved using a processor of an apparatus for example. The apparatus may also comprise the differential capacitive pressure sensor.

Although capacitive sensors are discussed above, it is to be noted that in some exemplary embodiments the sensor may be a different type of sensor. For example, a pressor sensor may be used as a barometric sensor. In such an exemplary embodiment, the sensor may comprise an electrode plate and a sensor membrane is placed such that it is above a vacuum. In such an exemplary embodiment, a force applied to the sensor membrane such that the sensor membrane is undeflected may be electrostatic feedback force that pulls the membrane such that it is undeflected thereby keeping the area of the sensor membrane constant.

It is also to be noted that in some exemplary embodiments, the sensor may be a piezoresistive sensor. In such an exemplary embodiment, the force applied to keep the sensor membrane comprised in the sensor undeflected may be electrostatic feedback force. The sensor membrane may be determined to be undeflected based on piezoresistive measurements.

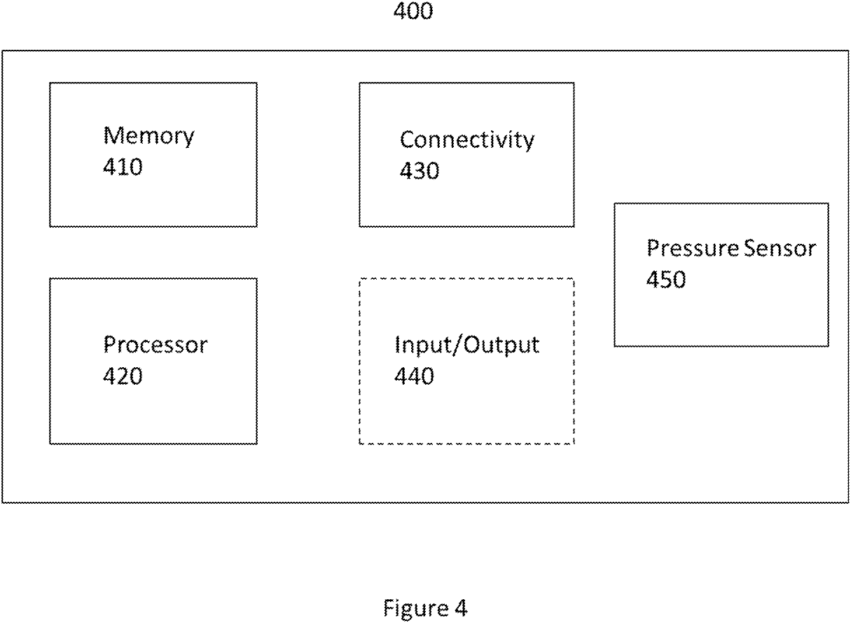

FIG. 4 is an example of an apparatus that may comprise an apparatus, such as the apparatus 200 configured to sense pressure. In this exemplary embodiment such apparatus is called a pressure sensor 450. The apparatus 400 may be, for example, a circuitry or a chipset applicable to a device to realize the described embodiments. The apparatus 400 may alternatively be an electronic device comprising one or more electronic circuitries. The apparatus 400 may comprise a memory 410 that may be implemented using any suitable data storage technology, such as semiconductor-based memory devices, flash memory, magnetic memory devices and systems, optical memory devices and systems, fixed memory and removable memory. The apparatus 400 may also comprise a processor 420 that comprises circuitry capable of executing computer program commands.

The apparatus 400 may further comprise a connectivity circuitry 430 that enables the apparatus to connect to a network which may be wired or wireless, such as a wireless local area network or a cellular wireless network. The apparatus 400 may optionally further comprise an input/output unit 440 that is configured to enable interaction between the apparatus and a user. The input/output unit 440 may enable text input, touch input, displaying of graphics, voice input and audio output for example.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), tensor processing units (TPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium.

1. An apparatus comprising at least one electrode and a movable sensor membrane, wherein the apparatus further comprises: at least one processor, and at least one memory including a computer program code, wherein the at least one memory and the computer program code are configured, with the at least one processor, to cause the apparatus to:
measure a voltage or a current;
determine an amount of membrane deflection based on the measured voltage or current;
based on the determined amount of membrane deflection, provide electrostatic feedback force such that the movable sensor membrane is undeflected; and
determine an external pressure based on the electrostatic force feedback.

2. An apparatus according to claim 1, wherein the voltage is measured and the voltage is AC, DC or pulsed DC.

3. An apparatus according to claim 1 wherein the voltage measured is a feedback voltage.

4. An apparatus according to -claim 1, wherein the electrostatic feedback force is caused by a compensation voltage.

5. An apparatus according to -claim 1, wherein the apparatus is further caused to determine a mid-point of the movable sensor membrane.

6. An apparatus according to claim 5, wherein the mid-point is determined based on an obtained capacitance measurement.

7. An apparatus according to claim 5, wherein the mid-point is determined based on a piezo-resistive measurement.

8. An apparatus according to claim 5, wherein the mid-point is determined based on optical measurement.

9. An apparatus according to -claim 1, wherein determining the external pressure further comprises determining the external pressure based on a correlation between the electrostatic force feedback and the external pressure.

10. An apparatus according to claim 1, wherein the apparatus comprises a sensor.

11. An apparatus according to claim 10, wherein the sensor comprises a barometric structure.

12. An apparatus according to claim 10, wherein the sensor comprises a differential structure.

13. An apparatus according to claim 12, wherein the sensor is a differential capacitive micro electro-mechanical system pressure sensor.

14. A method comprising:
measuring a voltage or a current;
determining an amount of membrane deflection based on the measured voltage or current;
based on the determined amount of membrane deflection, providing electrostatic feedback force such that the movable sensor membrane is undeflected; and
determining an external pressure based on the electrostatic force feedback.

15. (canceled)

16. A method according to claim 14, wherein the voltage measured is a feedback voltage.

17. A method according to claim 14, wherein the method further comprises determining a mid-point of the movable sensor membrane.

18. A method according to claim 16, wherein the mid-point is determined based on an obtained capacitance measurement.

19. A method according to claim 16, wherein the mid-point is determined based on a piezo-resistive measurement.

20. A method according to claim 14, wherein determining the external pressure further comprises determining the external pressure based on a correlation between the electrostatic force feedback and the external pressure.

21. A computer program product readable by a computer apparatus and, when executed by the computer apparatus, is configured to cause the computer apparatus to perform:
measuring a voltage or a current;
determining an amount of membrane deflection based on the measured voltage or current;
based on the determined amount of membrane deflection, providing electrostatic feedback force such that the movable sensor membrane is undeflected; and
determining an external pressure based on the electrostatic force feedback.
